(19) United States
(12) Patent Application Publication
(10) Pub. No.: US 2012/0216876 A1
(43) Pub. Date: Aug. 30, 2012

(54) Suppression and Separation of Interactive Acoustic Modes in a Fluid-Filled Resonator

(75) Inventors: D. Felipe Gaitan, Nevada City, CA (US); Joel Gutierrez, Grass Valley, CA (US)

(73) Assignee: IMPULSE DEVICES INC., Grass Valley, CA (US)

(21) Appl. No.: 13/298,270

(22) Filed: Nov. 16, 2011

Related U.S. Application Data
(60) Provisional application No. 61/414,347, filed on Nov. 16, 2010.

(51) Int. Cl. F17D 3/00

(52) U.S. Cl. 137/13

(57) ABSTRACT

A method and an apparatus for systematic suppression and separation of interactive acoustic modes within a liquid-filled spherical resonator are described. The method and apparatus allow for augmenting the response and acoustic energy of liquid-filled spherical shell resonators. In some aspects, manipulation of acoustic resonant modes is used to achieve desirable conditions. The response of a system can be influenced by one or more of the interactive modes, which are more sensitive to a change in the speed of sound. This is attained in some cases by changing parameters, which are a function of the speed of sound in a liquid medium, such as, temperature and pressure.

### RELATED APPLICATIONS

The present application claims the benefit of Provisional Application No. 61/414,347, bearing the same title, filed on Nov. 16, 2010, which is hereby incorporated by reference in its entirety.

### STATEMENT OF FEDERALLY SPONSORED RESEARCH OR DEVELOPMENT

This work was funded in part by the U.S. Government under Contract No. W9113M-07-C-0178, awarded by the U.S. Space and Missile Defense Command and subcontracted to the present Assignee. Accordingly, the U.S. Government may have certain rights to the subject matter herein.

### TECHNICAL FIELD

The present application relates to resonators for applying acoustic energy to fluids contained therein. More particularly, the present application describes high-intensity acoustic resonator chambers and the manipulation of acoustic resonant modes to achieve desirable conditions.

### BACKGROUND

The desirability of a liquid-filled acoustic resonator, which can efficiently transfer power from the drivers and shell to the bulk with minimal loss or damping, has been recognized. Until recently it has not been possible to achieve high quality factors (Q's) with large acoustic standing waves and high static pressures. This is in part due to resonator fabrication tolerances, design, and construction. However, in practice, this can be also be attributed to the interaction between the bulk and shell modes. Detrimental to the response of the resonator, the interactive modes can destructively interfere and/or dampen and absorb the acoustic pressure field by energy transference from one mode (usually radial) to another (anti-symmetric).

It is known that acoustic fields can be applied to fluids (e.g., liquids, gases) within resonator vessels or chambers. For example, standing waves of an acoustic field can be generated and set up within a resonator containing a fluid medium. The acoustic fields can be described by three-dimensional scalar fields conforming to the driving conditions causing the fields, the geometry of the resonator, the physical nature of the fluid supporting the acoustic pressure oscillations of the field, and other factors.

One common way to achieve an acoustic field within a resonator is to attach acoustic drivers to an external surface of the resonator. The acoustic drivers are typically electrically driven using acoustic drivers that convert some of the electrical energy provided to the drivers into acoustic energy. The energy conversion employs the transduction properties of the transducer devices in the acoustic drivers. For example, piezo-electric transducers (PZT) having material properties causing a mechanical change in the PZT corresponding to an applied voltage are often used as a building block of electrically driven acoustic driver devices. Sensors such as hydrophones can be used to measure the acoustic pressure within a liquid, and theoretical and numerical (computer) models can be used to measure or predict the shape and nature of the acoustic field within a resonator chamber.

If the driving energy used to create the acoustic field within the resonator is of sufficient amplitude, and if other fluid and physical conditions permit, cavitation may take place at one or more locations within a liquid contained in an acoustic resonator. During cavitation, vapor bubbles, cavities, or other voids are created at certain locations at times within the liquid where the conditions (e.g., pressure) at said certain locations and times allow for cavitation to take place.

Acoustic resonators have been designed in a variety of configurations, in a multitude of applications in the art. For example, resonators made from an assortment of metals and steel have been devised. Also, resonators having metal walls with sapphire or quartz optical viewing ports have been devised. Some such resonators have been made by Impulse Devices, Inc. of Grass Valley, Calif., for which various patent applications have been filed by the present applicant.

It has not been possible or practical in the prior art to systematically achieve large acoustic standing waves and high quality factors (Q) in acoustic resonators, especially with respect to the manipulation of interactive modes. Also, such resonator systems have not been optimized by analytical changes in medium temperature and pressure for use in cavitation environments under high static pressures to achieve elevated energy densities.

### SUMMARY

In some aspects, increasing the energy density of acoustically induced liquid cavitation is desired. Energy density is known to increase with static pressure in the liquid. However, increases in static pressure significantly affect the position in frequency space of some of the anti-symmetric modes, sometime producing an intractable result.

As described below, the response of a system may augmented by influencing one or more of the interactive modes which are more sensitive to a change in the speed of sound. This is attained by changing parameters, which are a function of the speed of sound in a liquid medium, such as, temperature and pressure.

Aspects of the present disclosure are directed to methods to suppress and separate interactive resonant modes by manipulating the speed of sound in a given medium. A primary objective of the present invention is to enhance the energy densities, principally in one or more predetermined locations or foci (i.e., pressure anti-nodes). In one or more embodiments, this is performed by changing the temperature of the liquid medium, either directly or indirectly (e.g., conduction, convection, or radiative). In other embodiments, the adjustment to the speed of sound is made by modest variations in static pressure.

### BRIEF DESCRIPTION OF THE DRAWINGS

For a fuller understanding of the nature and advantages of the present concepts, reference is be made to the following detailed description of preferred embodiments and in connection with the accompanying drawings, in which:

FIG. 1 illustrates an acoustic resonator system according to the experimental set-up of the present invention;

FIG. 2 illustrates an exemplary observed change in quality factor Q of a spherical resonator of a given size and wall thickness as a function of internal fluid pressure;

FIG. 3 illustrates the pressure dependence of certain frequencies in certain modes of a spherical resonator;

FIGS. 4-7 illustrate an exemplary scenario using the present method whereby a desired mode is shifted along the characteristic frequency axis relative to a non-desired mode of a spherical resonator; and

FIG. 8 graphically depicts the frequency versus mode number for several modes in spherical resonator up to a azimuthal index of n=10;

### DETAILED DESCRIPTION

As discussed above, it is useful to have acoustic modes which can readily and systematically be manipulated for a desired outcome. In addition, it is useful to have a well-designed resonator system for certain purposes, which may require controllable static pressures and temperature within a fluid medium, and custom or pre-configured or configurable interactive modes.

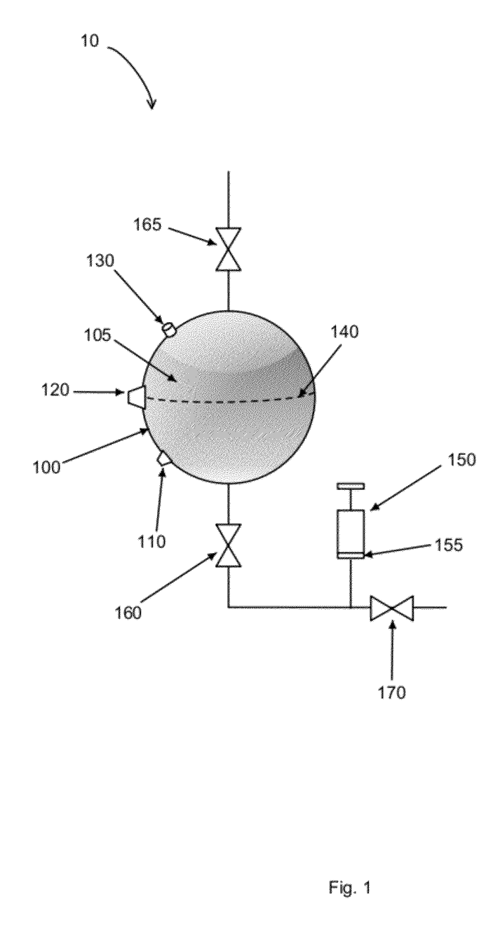

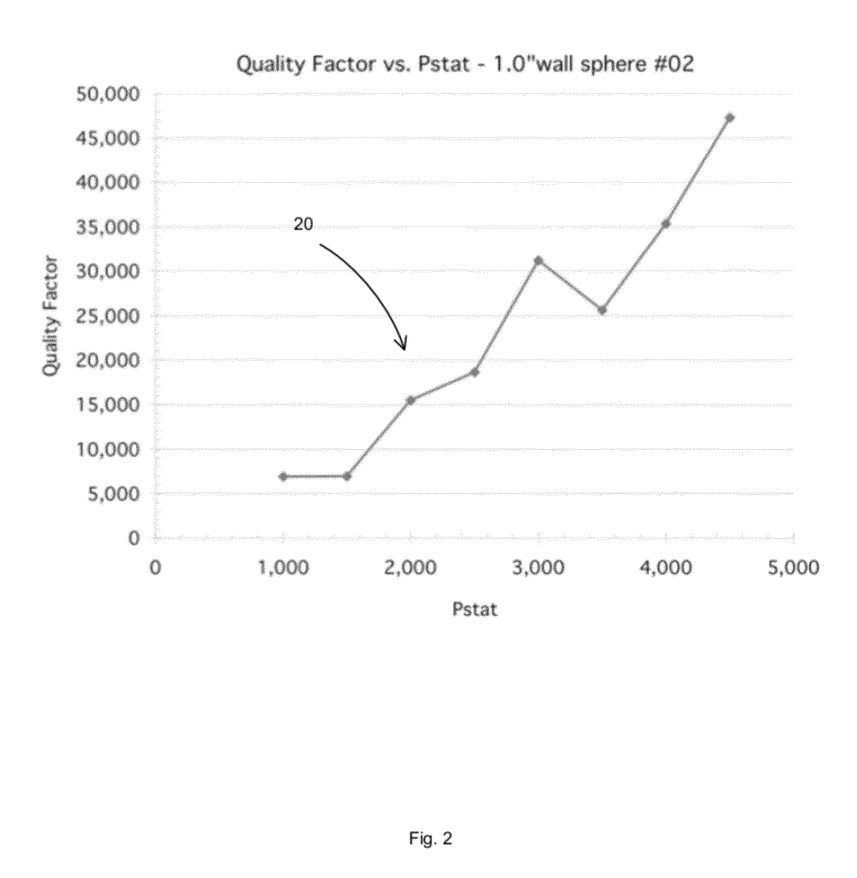

FIGS. 1 and 2 show simplified diagrams of an acoustic resonator or cavitation system according to some embodiments. A resonator 100 contains a volume of fluid 105, which is to be cavitated. An acoustic driver 110 such as a PZT transducer is fixed to a location on the resonator cavitation chamber 100. The coupling is typically done by screw attachment or epoxy attachment of transducer 110 to chamber 100.

Acoustic transducer 110 may be driven at a selectable frequency and power so as to efficiently cause resonance in the cavitation chamber 100 and specifically so as to cause cavitation within the volume of the fluid 105 within the resonator.

In some embodiments, a pressure source such as a fluid pump or a compressor 150, can provide static fluid pressure to the volume 105, for example, by turning a threaded screw in a cylinder of compressor 150 so as to move a piston 155 against a contained liquid therein. Applying positive static pressure to the volume within cavitation chamber 100 may lead to favorable and more intense acoustic cavitation activity therein. For reference, a mid-section or “equator” 140 can be defined with respect to the driver transducer 110 so that the equator (dashed line) bisects the body of the spherical resonator chamber 100. Acceleration of a portion of the surface of the body can then be measured with an accelerometer, as discussed below, with respect to the accelerometer's location from the equator.

A hydrophone 130 may be inserted into an interior location of the volume 105 to monitor the acoustic field at the location of the hydrophone. Also, a pulse-echo transducer may be mounted onto a surface of cavitation chamber 100 to actively monitor for the presence of cavitation bubbles within the chamber. In yet further embodiments, an accelerometer 120 may also be secured to a portion of the resonator 100 so as to monitor the displacement and acceleration of the shell of the body of the cavitation chamber.

The cavitation system 10 may be coupled to a fluid circuit by way of one or more valves 160, 165, 170. In some embodiments, valve 160 isolates the contents of the volume 105 within resonator 100 from the pressure source 150. A valve 165 may similarly isolate the fluid contents of the resonator 100 from other portions of the system and may allow for selective coupling of the resonator 100 to fluid filters or degassing units. Other fluid pumps may be isolated from the system 10 by way of valve 170.

The system 10 includes an acoustic resonator chamber 100, which may be a spherical resonator constructed of a solid material such as stainless steel and which may have a diameter between two inches and thirty inches according to some embodiments, but which diameter is not intended here by way of limitation. In a specific embodiment, the diameter of the spherical shell of resonator 100 is approximately ten inches. The solid shell of resonator 100 may vary in thickness depending on the application at hand, including the pressure which needs to be sustained within the interior of the resonator, the acoustic parameter which are to be applied to the resonator, the material from which the resonator is constructed, and other factors. In some embodiments, the thickness of the shell of the body of resonator 100 is between 0.1 and 2 inches, and in yet other embodiments it is between one half of an inch thick and one inch thick. In still other embodiments, the thickness of the shell is approximately three quarters of an inch thick.

As described earlier, an acoustic driving assembly or transducer 110 is coupled to at least one portion of resonator 100. It should be appreciated that more than one driving transducer 110 could be fixed to resonator 100, which plurality of drivers 110 may then be driven in unison or in some other coordinated fashion. The purpose of driver 110 is to achieve an acoustic energy input into resonator in volume 105, which in some embodiments facilitates acoustic cavitation in a fluid within the resonator.

As is known, electrical driving signals are used to drive acoustic transducers 110. However, what is intended is not to limit the present discussion, but rather to illustrate common or preferred embodiments of the present system. Therefore, an exemplary and simplified circuit for driving transducer 110 will be described. A computerized processor such as those available in general purpose computer and processing machines is used to compute or output desired parameters for driving acoustic transducer 110. An arbitrary wave form generator receives the desired signal properties from the processor and generates a wave form accordingly. The wave form generated by the wave form generator may be amplified by a power amplifier and provided as an input to transducer assembly 110. An oscilloscope or other electrical test probe may be used to monitor the driving signal provided to transducer assembly 110.

Under certain conditions, the acoustic action of the transducer and the chamber set up an acoustic field within the fluid in the chamber that is of sufficient strength and configuration to cause acoustic cavitation within a region of chamber 100. Specifically, under suitable conditions, acoustic cavitation of the fluid in the chamber may cause bubbles or acoustically-generated voids as described above and known to those skilled in the art, to form within one or more regions of the chamber. The cavitation usually occurs at zones within the chamber that are subjected to the most intense (highest amplitude) acoustic fields therein. Sensors such as photomultiplier tubes or photon detectors can be employed to detect sonoluminescent or other energetic electromagnetic emissions from within the central cavitation zone in chamber 100.

The systems may further include a fluid circuit including a pump to change the static pressure therein. The fluid circuit includes a fluid driver (e.g., a pump such as a rotary or reciprocating pump) or other piston compressor 150. A pressure gauge may be installed at a useful location downstream of pump to monitor the pressure at its highest value downstream of pump. A filter may be used inline with the flowing fluid to trap any impurities or dirt in the fluid.

A solenoid or gate valve may be used to secure the fluid flow in some cases or to isolate the resonator upstream of the resonator. A second solenoid valve is used to secure flow of the fluid or to isolate the resonator in cooperation with valve.

A relief value may be provided as a safety mechanism to relieve fluid from the system if the pressure of said fluid exceeds a pre-determined threshold. For example, the relief valve may be set to discharge fluid in a controlled way if the pressure within resonator approaches a value that could jeopardize the integrity of the resonator or other system components. These and other fluid circuit components may be in fluid communication with the illustrated resonance chamber by way of valves 160, 165.

A fluid flow rate meter may be used to sense and provide an indication of the rate of fluid flow (e.g., in cubic centimeters per second) through the fluid system. Because the fluid is generally incompressible, the fluid flow rate in the outlet portion of the system (as pictured) is substantially the same as the flow rate at the inlet to the resonator.

A fluid holding, storage, surge or expansion tank or reservoir can be provided to contain an adequate amount of fluid and mediate any volumetric or pressure surges in the system. A temperature sensor (thermometer) is used to provide an indication of the temperature of the fluid in the system.

The present inventors recognized that the behavior of the system 10 (acoustically and mechanically and otherwise) is affected by the conditions provided in a fluid under cavitation within the resonance chamber 100. Specifically, that the resonance performance and efficiency of the system 10 can be affected by changing certain parameters and conditions as described below, enabling the inventors to achieve very efficient cavitation systems requiring lower driving powers and yielding greater cavitation intensity. In some aspects, applying a static pressure to a fluid (e.g., a liquid) within the cavitation resonance chamber, and further controlling a baseline (DC or bias) fluid pressure and temperature within said chamber was found to permit control of the various resonance modes of the driven resonance chamber. Discussion below of the underlying physics of the resonance (which is generally understood from a mathematical point of view) but more specifically as relates to the present method for achieving greater cavitation efficiency at a same or lower power than previously achievable is provided.

Still more particularly, the present method addresses and exploits that the overall quality factor (Q) of a resonator can be affected by the internal fluid pressure therein under cavitation conditions, and further that certain modes affecting said quality factor Q can be manipulated as described below by appropriate control and driving of the fluid and cavitation system.

A further feature hereof is the controlled exploitation of the relationship between the plurality of resonance and oscillatory modes and motions of a cavitation chamber of spherical geometry, but this notion can apply to other higher order geometries without loss of generality as would be appreciated by those skilled in the art. The present description applying to spherical geometries is for illustrative purposes.

The present technique, in some aspects, permits reduction or elimination of interference between the plurality of vibrational, breathing, and other modes of resonance of spherical type resonators. And in some aspects, this allows for increased Q factor operation and greater cavitation effectiveness and efficiency at reduced power.

FIG. 2 illustrates an exemplary observed change in quality factor Q of a spherical resonator of a given size and wall thickness as a function of internal fluid pressure. The drawing is merely exemplary, and those skilled in the art appreciate that numerous other factors may influence the quality factor Q of a spherical resonator.

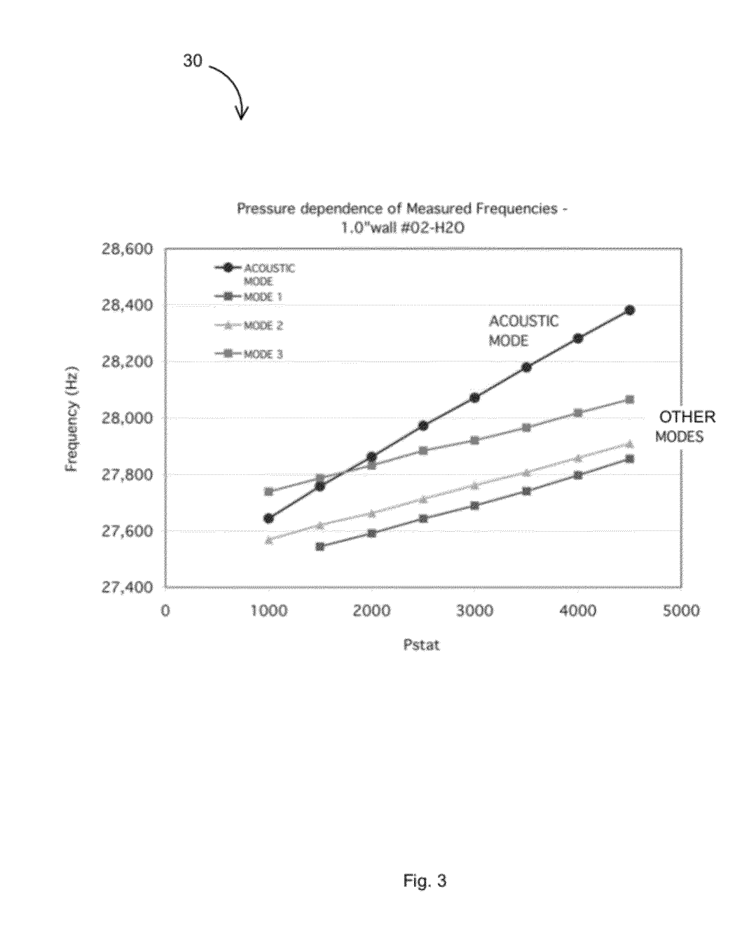

FIG. 3 illustrates the presence and dependence of certain frequencies measured as a function of applied static pressure in a fluid within a spherical resonator. An acoustic (sometimes “breathing” or “n=0”) mode's characteristic frequency, as well as other modes, are shown on plots 30 as a function of static pressure P_stat. One can see that the oscillatory and resonance modes of such a sphere would be affected by the various parameters within the sphere, which will be explained below in how these can provide for stronger cavitation environments. In some embodiments, controlling the sound speed of the fluid being cavitated, for example by controlling its static pressure and/or its temperature is used to control the sound speed of the fluid and therefore the resulting acoustic fields and response of the resonator system. This is because the speed of sound in a fluid is known to be a function of its temperature, among other factors. The specific relationship between temperature, pressure and speed of sound of a fluid are known (or knowable) to those skilled in the art and are not discussed in detail herein.

It was determined that while breathing or acoustic or n=0 resonance modes of a sphere are favorable to achieving cavitation therein, other modes (e.g., shell or surface modes) are not. According to some aspects, the present method avoids or minimizes the interaction between the favorable and non-favorable modes of oscillation of a resonator chamber. For example, if the favorable modes of oscillation (for example the n=0 modes) occur at the same or too close a frequency as the other non-favorable modes (for example shell modes) this could cause a transfer of energy between these modes, in effect depriving the system of the energy in the favorable mode and depositing energy into a non-favorable mode. In an example, the breathing mode is degraded and a shell mode is enhanced at its expense, thereby causing energy losses by mechanical, noise, friction, molecular, and other wasteful mechanisms. The result is a reduced effectiveness of a cavitation resonator system, and an increase in power needed to drive the acoustic drivers to cause cavitation therein. Again, note that the present example is given by way of illustration for the relatively simplified case of a spherical shell resonator, but those skilled in the art would understand that other primary modes and other destructive modes could and do exist for other geometries, which are not discussed here for clarity and simplicity of presentation.

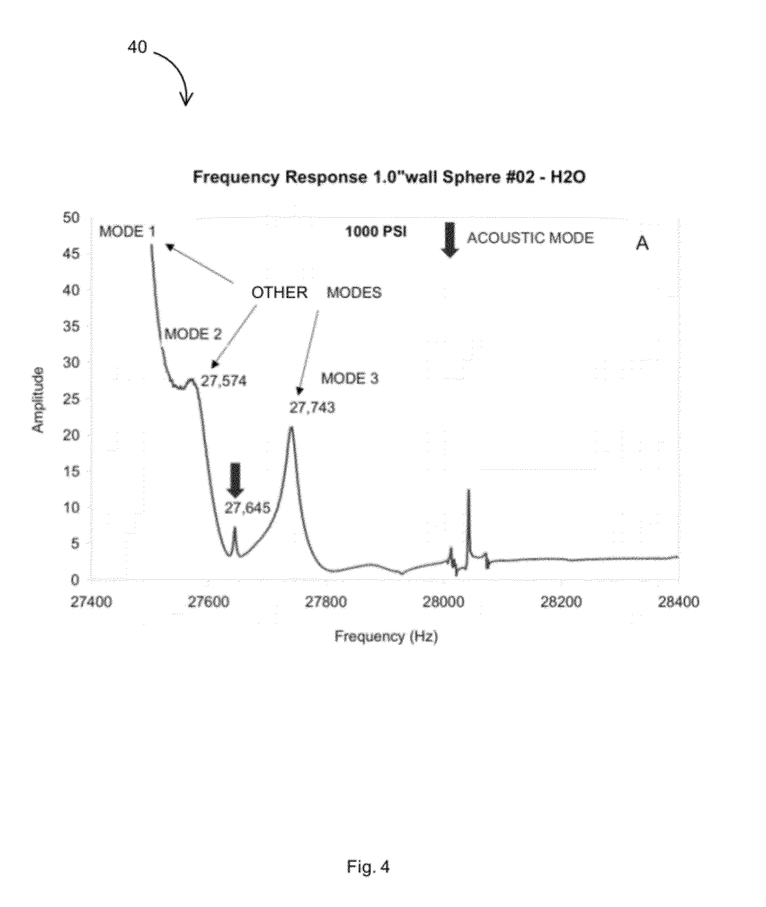

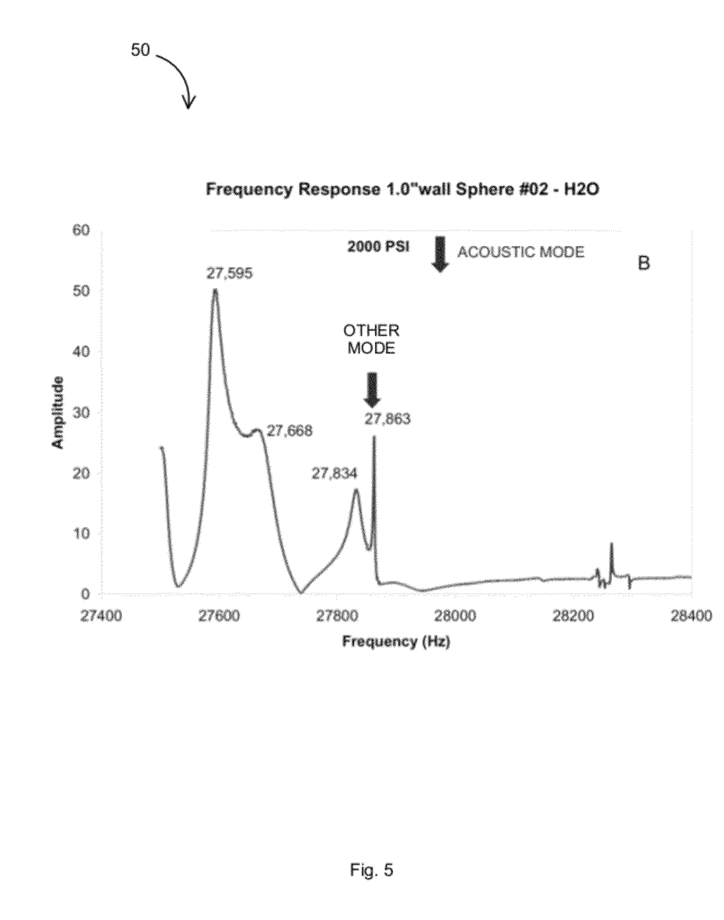

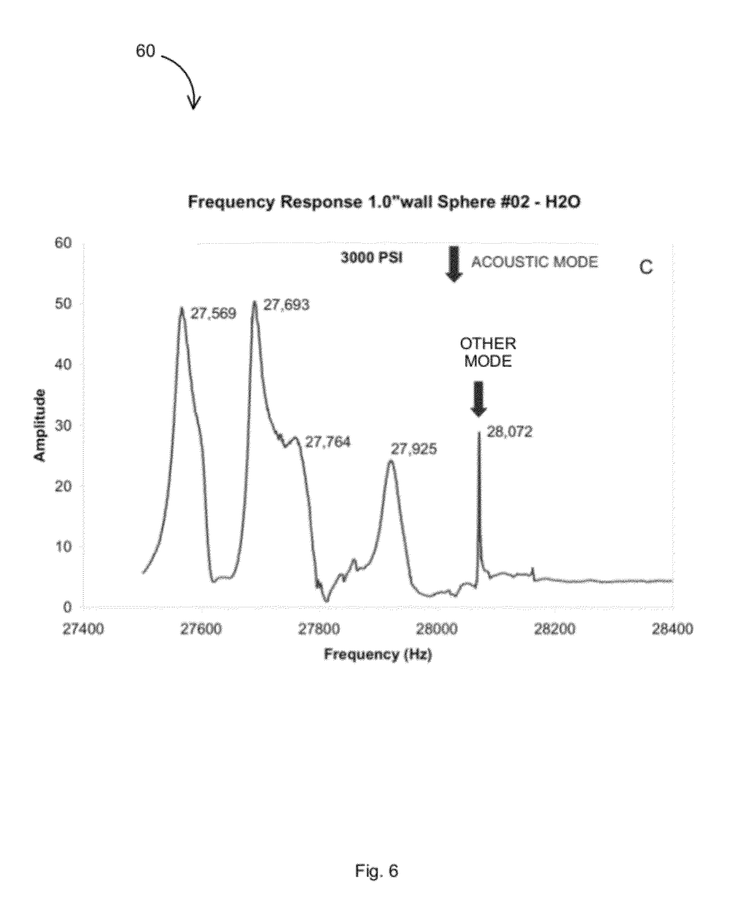

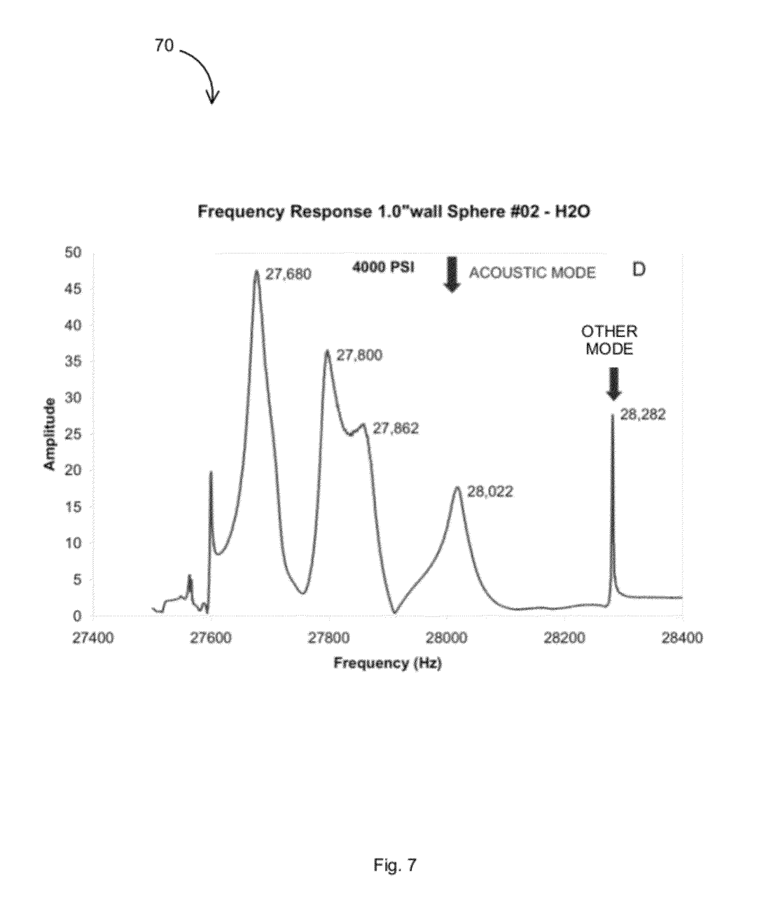

FIGS. 4-7 illustrate an exemplary scenario using the present method whereby a desired mode is shifted along the characteristic frequency axis relative to a non-desired mode of a spherical resonator. In some aspects, it can be useful to keep non-favorable modes away from the favorable modes so that the resonator can be efficiently driven at the desired mode's frequency to achieve greater cavitation activity in the resonator, e.g., at or near its center. The present method in part teaches how to control mode-to-mode interaction so as to obtain a more forceful cavitation environment in a resonator system such as a spherical resonator.

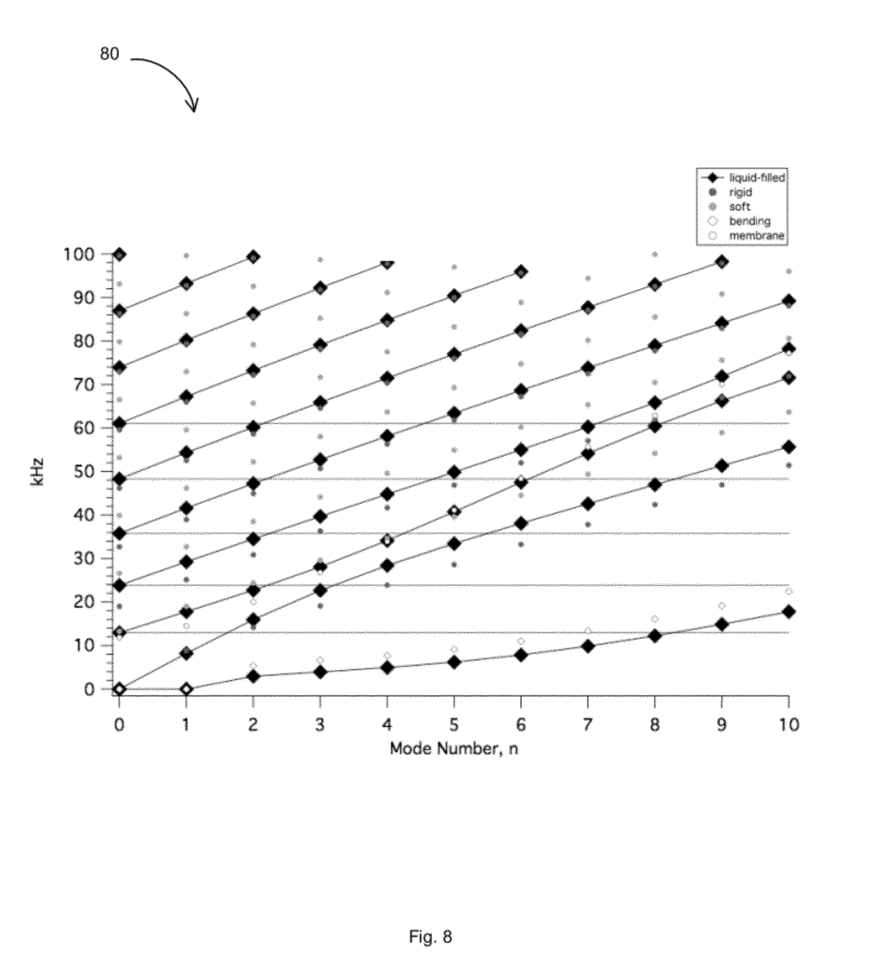

FIG. 8 illustrates by way of example the lower resonant modes of a stainless steel spherical resonator, including rigid, soft, breathing and membrane. As shown, several of the modes are very close to one another in frequency space and care should be exercised to avoid confusion. These modes may furthermore overlap in certain conditions. In situations where two modes are close to one another, it is possible for one mode to capture energy from the other mode.

As can be seen, the applicant has observed the above phenomenon while perturbating the breathing mode, for example. Another non-radial mode proximate to the breathing mode continually seized its energy making the build-up of acoustic energy within the standing wave difficult. Acoustic mode-mixing or interaction may prevent or diminish high amplitude cavitation and desired elevation of energy densities.

The present illustrations are confirmed by experiments performed using water and other liquids including liquid Gallium in a spherical resonator under pressure. In one exemplary embodiment, this is accomplished by lowering the speed of sound down to 1525 meters per second. As will be analytically seen, separation occurs due to the disparity between the two modes' speed of sound sensitivity. The non-radial mode frequencies are less sensitive to changes in speed of sound (such that, changes in temperature and pressure). To this end, aspects of the invention provide a way to manipulate resonant modes in a discriminating fashion (e.g., non-uniformly).

FIG. 8 graphically illustrates a plot 80 of exemplary eigenvalues of frequency as a function of sound speed. As a function of speed of sound, the eigenfrequencies with a steeper slope naturally exhibit behaviors more sensitive to changes in temperature and pressure (which affect speed of sound). Accordingly, as dF_{eigen}/dS_{sound} approaches zero for a given mode, said mode would be entirely insensitive to changes in temperature and pressure with respect to its “natural” frequencies. The slopes of modes (7, 1) and (0, 3) affirm our previous observation and subsequent manipulation. In that, the (0, 3) breathing mode is very sensitive to changes in speed of sound, relative to the non-radial (7, 1) mode.

The following mathematical derivation is given by J. B. Mehl (J. Acoust. Soc. Am. 78, 782-788), and is intended to support a reader's understanding of the physics at play in the present embodiments.

In a fluid-filled spherical shell, the velocity potential in the fluid is governed by the Helmholtz equation:

∇²φ+(ω/c_{w})²φ=0

The shell displacement is governed by the elastodynamic equation:

cₗ²∇∇·\vec{s}−cₜ²∇×∇×\vec{s}+ω²\vec{s}=0

Application of suitable boundary conditions leads to the system of equations where A is a 5×5-element matrix and B a five element column vector whereby AB=0. The eigenfrequencies are frequencies that satisfy:

det(A)=0, Aᵢᵢ=f(ω, c_{w})

FIG. 8 uses the following mode labeling: (n, s); where, n for azimuthal index and s for radial index.

In one or more embodiments, heat tape (resistive heating element) is used to change the temperature of the medium. In other embodiments, a heater using convection can be used to augment the liquid-filled sphere. To decrease media temperature, refrigeration can be utilized. Or, in other embodiments, cans of “freezer spray” (Tetrafluoroethane, etc) or similar will function to change temperature when applied to sphere surface.

According to another embodiment, a high-pressure mechanical pump can be used to change the internal pressure thereby affecting speed of sound. Pursuant to another aspect of the invention, an electro-mechanical pump may be used in conjunction with a feedback loop to monitor and maintain a constant pressure, especially under condition of changing temperature. Liquid under the force of gravity can be used to alter pressure and is not beyond the present scope.

The present invention should not be considered limited to the particular embodiments described above, but rather should be understood to cover all aspects of the invention as fairly set out herein. Various modifications, equivalent processes, as well as numerous structures to which the present invention may be applicable, will be readily apparent to those skilled in the art to which the present invention is directed upon review of the present disclosure.

1. A method for controlling an acoustic field in a cavitation resonance chamber, comprising:
coupling at least one acoustic driver to at least one corresponding location on a body of a cavitation resonance chamber;
driving said at least one acoustic driver with an electrical driving signal;
simultaneously exciting a plurality of acoustic modes in said body of said resonance chamber; and
altering a first characteristic frequency of a first acoustic mode of said body of said resonance chamber relative to a second characteristic frequency of a second acoustic mode of said body of said resonance chamber.

2. The method of claim 1, altering said first characteristic frequency relative to said second characteristic frequency comprising altering a property of a fluid within said body of said resonance chamber.

3. The method of claim 2, altering said property of said fluid comprising altering a speed of sound of said fluid.

4. The method of claim 3, altering said speed of sound comprising altering a temperature of said fluid.

5. The method of claim 3, altering said speed of sound comprising altering a static pressure of said fluid.

6. The method of claim 1, further comprising determining eigenfrequencies applicable to said plurality of acoustic modes.

7. The method of claim 6, further comprising altering a sound speed of a fluid within said body of said resonance chamber so as to match a first and second eigenfrequency corresponding to respective first and second modes at a given sound speed of said fluid.

8. The method of claim 1, further comprising providing a static fluid pressure greater than atmospheric pressure within said body of said resonance chamber.

9. The method of claim 1, further comprising causing acoustic cavitation within a fluid within said body of said resonance chamber.

10. The method of claim 1, further comprising monitoring for cavitation activity within a fluid within said body of said resonance chamber.

11. The method of claim 10, said monitoring comprising observing using a photon detector.

12. The method of claim 10, comprising application of pulse-echo steps to indicate the presence of a cavitation bubble within said fluid.
